(19) United States
(12) Patent Application Publication
(10) Pub. No.: US 2007/0151817 A1
(43) Pub. Date: Jul. 5, 2007

(54) Railway Vehicle Brake Shoe

(75) Inventors: Joseph C. Kahr, Southern Pines, NC (US); Joseph F. Formolo, Laurinburg, NC (US)

Correspondence Address: THE WEBB LAW FIRM, P.C., 700 KOPPERS BUILDING, 436 SEVENTH AVENUE, PITTSBURGH, PA, 15219, US

(73) Assignee: RFPC HOLDING CORP., Wilmerding, PA (US)

(21) Appl. No.: 11/567,559

(22) Filed: Dec. 6, 2006

Related U.S. Application Data
(60) Provisional application No. 60/749,744, filed on Dec. 13, 2005.

(51) Int. Cl. F16D 69/00

(52) U.S. Cl. 188/250 R

(57) ABSTRACT

A railway brake shoe including a first layer constructed of a composition friction material and a second layer constructed of a resilient composition material. The second layer is joined to the first layer. The second layer is adapted to receive at least one mechanical fastener therein to removably secure the brake shoe to a brake head. The resilient material of the second layer is capable of applying a circumferentially compressive force to the at least one mechanical fastener and prevent breakage of the composition friction material at the attachment location and/or enlargement of the attachment apertures due to vibration and lateral impacts.

### BACKGROUND OF THE INVENTION

1. Field of the Invention

The present invention relates generally to railway vehicle brake shoes and, more particularly, to a layered composition brake shoe having noise reduction characteristics.

2. Description of Related Art

A certain type of railway transit car, which utilizes a pneumatic tire suspension system in conjunction with secondary steel safety wheels for braking, is equipped with a wooden type of brake shoe, which is typically mounted to a supporting brake head via screws that project through the face of the brake head and are embedded into the body of the brake shoe. Such wooden type brake shoes have been used on these vehicles because, heretofore, other types of composition brake shoes have caused excessive brake squeal when the brake is applied to the steel safety wheels of these vehicles. The tendency for noise is related to the unique shape of the wheel and the suspension of the wheel on the same axle that is supported by the transit car pneumatic tire suspension system. In this system, the steel safety wheel is used primarily for the braking function, without contacting a rail or roadway surface during vehicle operation. It has been known that wooden type brake shoes are most resistant to noise generation and that the existing mounting arrangement on such vehicles is reliable for the wooden type brake shoes. Prior art brake shoe attachment techniques involve screwing brass screws directly into the structure of the wooden type brake shoes.

In the case of composition brakes, development of a successful composition material to replace wood has been hampered by the inability of composition friction materials, with the appropriate friction and noise reduction qualities, to retain contact with threads of the brass screws in the same manner as natural wood. Specifically, natural wood predominantly has its fibers aligned and reinforced by a grain structure, whereas the particles of any fiber content in a composition material is typically aligned in a random fashion that creates multiple fault lines around the fastener (e.g., threaded connection of the brass screws). The attachment of the brake shoe is thereby susceptible to material breakage and pull out of the screws. This is due to force exerted at stress concentration zones in contact with the screw threads as the screw is inserted, or as the assembly reacts to dynamic loading during usage of the brake system.

One previous brake shoe attachment technique incorporated a metal backing plate with extended tabs as an integrally molded unit, as is disclosed in U.S. Pat. No. 6,302,247 to Kahr et al. Other forms of brake shoes are known from United States Patent Application Publication No. 2003/0155193 to Hays, Jr. et al., U.S. Pat. No. 5,595,266 to Cecere, U.S. Pat. No. 5,255,762 to Beri, and U.S. Pat. No. 6,474,452 to Velayutha. Hays, Jr. et al. disclose a brake pad assembly including a friction pad attached to a non-metallic backing plate which is constructed of non-metallic material. Cecere discloses a friction brake having a friction material brake lining element integrally adhered to a backing plate using interspersed epoxy resin. Beri discloses a brake shoe assembly, wherein a friction material is integrally molded around various retaining nuts resulting in a continuous outer surface. The friction material may be mounted flush against a support plate and bolts are then passed through bores to engage the retaining nuts. Velayutha discloses a lightweight, polymer based backing plate for use with a railway brake shoe or a disc brake pad that may be formed in situ during molding of the composite friction material. None of these prior forms is as effective as the brass screw attachment process for the purpose of noise abatement, ease and reliability of assembly, and structural integrity of the molded product.

### SUMMARY OF THE INVENTION

In view of the foregoing, there is a need for a brake shoe which possesses noise reducing qualities and which may replace conventional wood type brake shoes now commonly used in the railway vehicle field. Such a brake shoe may be constructed of integrally molded composition friction materials which are jointly adapted to function in the brake block, with one material providing the desired friction, noise and wear characteristics in the wearable portion, another composition material in the non-wearing layer having resilient characteristics for secure attachment directly to a brake head. The brake shoe provides a reliable mechanical attachment of composition friction brake material to brake heads or brake rigging of rail transit cars and other similar vehicles. A specific feature of the brake shoe is the ability to provide protection against breakage of the composition friction material near the attachment interface of the composition friction material with mechanical attaching members.

In one embodiment, the brake shoe includes a stratum or layer of resilient composition material that is compatible with the composition friction material portion of the brake shoe. This stratum is comprised of a thin layer of resilient composition material which is concurrently molded with the composition friction material. When the molding is completed, the resilient material acts to encapsulate the more friable friction material and provides a skin layer of material which applies a circumferential compressive force on the exterior surfaces of fasteners, such as screws, that penetrate the back of the brake shoe body for the purpose of attachment to the brake head. In addition to the compressive force exerted on penetrating fastener surfaces, the resilient stratum layer prevents localized breakage of the base friction material around the contact perimeter on the fastener, thereby maintaining the holding power of the fastener interface.

In another embodiment, the railway brake shoe comprises a first layer constructed of a composite friction material and a second layer constructed of a resilient composition material, the second layer is attached to a surface of the first layer, and adapted to receive at least one fastener therein. The second layer may be adapted to be removably secured to a brake head with the at least one fastener. The second layer may be adapted to receive the at least one fastener extending therethrough, and the first layer may be adapted to receive a predetermined portion of the at least one fastener therein.

The resilient composition material of the second layer is typically capable of applying a circumferential compressive force to an exterior surface of the at least one fastener. The resilient composition material of the second layer is typically capable of preventing localized breakage of the composite friction material of the first layer around a contact perimeter of the first layer with the at least one fastener and the second layer.

The second layer may be integrally molded with the first layer. The at least one fastener may comprise a plurality of fasteners and the plurality of fasteners may comprise, as an example, screws.

In another embodiment, the railway brake shoe comprises a first layer constructed of a composite friction material, a second layer constructed of a resilient composition and at least one aperture extending into the second layer material. The first layer has a first surface and a second surface, with the first surface capable of contacting a wheel during a braking operation. The second layer has a first surface and a second surface, with the first surface attached to the second surface of the first layer. The at least one aperture is adapted to receive at least one mechanical fastener therein for removable securement of the second surface of the second layer to such brake head.

The at least one aperture may extend through the second layer. The first layer may include at least one aperture extending a predetermined distance therein, with the at least one aperture extending into the first layer positioned in alignment with the at least one aperture extending through the second layer and adapted to receive a predetermined portion of the at least one mechanical fastener extending through the second layer.

The resilient composition material of the second layer is typically capable of applying a circumferential compressive force to an exterior surface of the at least one mechanical fastener. The resilient composition material of the second layer is typically capable of preventing localized breakage of the composite friction material of the first layer around a contact perimeter of the first layer with the at least one mechanical fastener and the second layer.

The second layer may be integrally molded with the first layer. The at least one mechanical fastener may comprise a screw. The first surface of the first layer composite friction material is desirably compatible for use with a safety wheel of a railway vehicle.

A further aspect of the brake shoe relates to a method of securing the brake shoe to a brake head for use with a railway vehicle. Generally, the method comprises providing a brake shoe comprising a first layer constructed of a composite friction material, and a second layer constructed of a resilient composition material attached to a surface of the first layer; providing a first aperture extending through the second layer; providing a second aperture in alignment with the first aperture, the second aperture extending a predetermined distance into the first layer of the brake shoe; and attaching the brake shoe to a brake head by means of a mechanical fastener extending into the first and second apertures.

The step of providing first and second apertures may comprise forming a plurality of first and second apertures in the first and second layers, and the step of attaching the brake shoe to the brake head may comprise the use of a plurality of screws.

Further details and advantages will be understood from the following description of the preferred embodiments, taken with the accompanying drawings, wherein like reference numerals represent like elements throughout.

### BRIEF DESCRIPTION OF THE DRAWINGS

FIG. 1 is a cross-sectional perspective view of a brake shoe;

FIG. 2 is a side view of the brake shoe of FIG. 1; and

FIG. 3 is a perspective, exploded view of the brake shoe of FIG. 1 mounted to a brake head.

### DETAILED DESCRIPTION OF THE INVENTION

For purposes of the description hereinafter, spatial or directional terms shall relate to the invention as it is oriented in the drawing figures. However, it is to be understood that the invention may assume various alternative variations, except where expressly specified to the contrary. It is also to be understood that the specific components illustrated in the attached drawings, and described in the following specification, are simply exemplary embodiments of the invention. Hence, specific dimensions and other physical characteristics related to the embodiments disclosed herein are not to be considered as limiting.

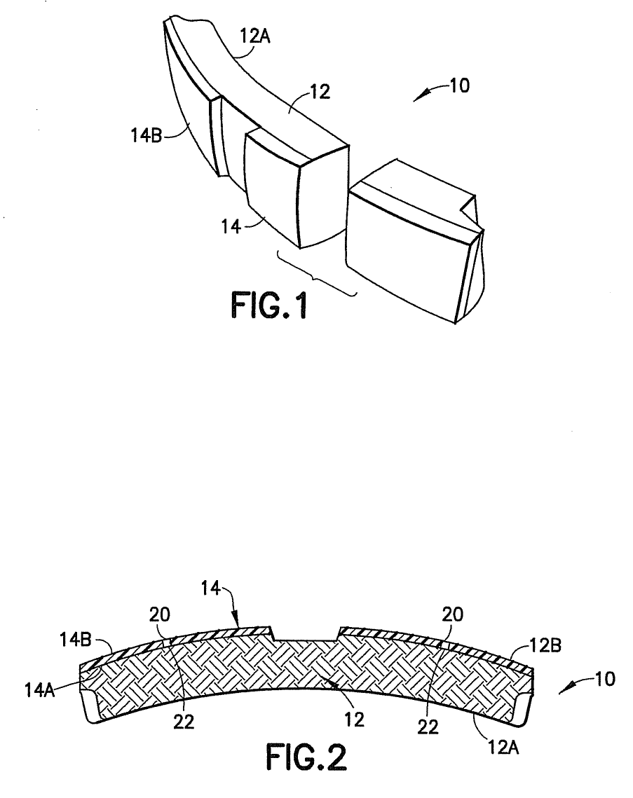

FIG. 1 depicts a brake shoe, generally indicated as 10, having a first layer 12, having a first surface 12A and a second surface 12B, and a second layer 14, having a first surface 14A and a second surface 14B. Desirably, as shown in FIG. 2, the first layer 12 is a composition friction material and the second layer 14 is a resilient material. The composition friction material is compatible with the resilient material so that the first surface 14A of the second layer 14 may be joined with the second surface 12B of the first layer 12 by any well-known means. Preferably, the second layer 14 is concurrently and integrally molded with the first layer 12. An exemplary thickness relationship between the resilient material stratum and the friction material stratum of the brake shoe 10 is also depicted in FIG. 2.

The composition of the friction material of the first layer 12 generally comprises a resin binder, an inorganic filler, cellulose and/or cotton fibers, and a lubricant. Any well known types of binders, fillers, fibers and lubricants can be used in the composition of the friction material. The composition of the resilient layer of the second layer 14 generally comprises a synthetic rubber, curatives, inorganic and/or organic fillers, and resin binder. Any well known types of synthetic rubbers, curative, fillers and binders may be used in the composition of the resilient layer.

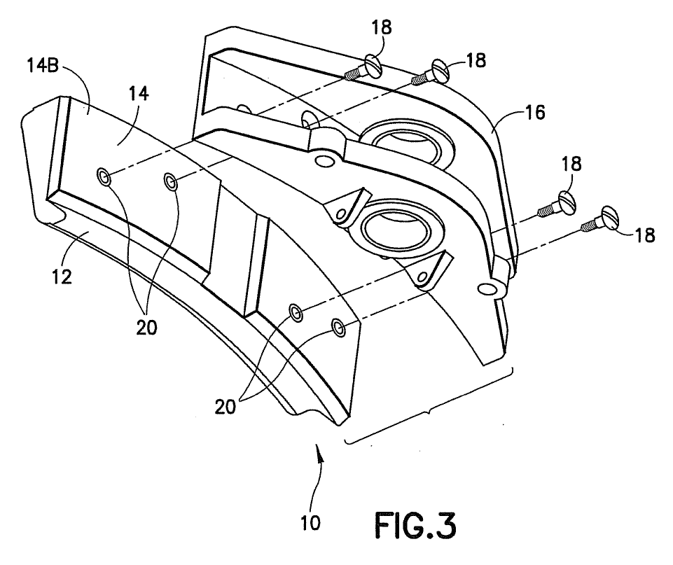

With continuing reference to FIGS. 1 and 2, FIG. 3 discloses the brake shoe 10 used in connection with a brake head 16. U.S. Pat. No. 6,302,247 to Kahr et al. discloses an exemplary brake head for use with the present invention brake shoe. However, it is to be understood that other suitable brake heads or brake rigging may be utilized in connection with the present invention. The brake head 16 is adapted to receive mounting screws 18 (e.g., screws) or other fasteners therethrough.

Accordingly, the process of assembly on the brake head 16 of the brake system rigging is accomplished by positioning the brake head 16 against the back of the brake shoe 10. Pilot holes or first apertures 20 are then drilled at the appropriate locations on the back surface of the brake shoe 10. These first apertures extend through the second layer 14. Second apertures 22 are drilled into the first layer 12 in alignment with the first apertures 20. These second apertures extend a predetermined distance into the first layer 12. Thus, the second layer 14 includes the first apertures 20 adapted to receive the mounting screws 18 which extend therethrough and enter into the second apertures 22 to extend a predetermined distance into the first layer 12. Thereafter, the mounting screws 18 are screwed into the brake shoe 10 to secure the second surface 14B of the brake head 16 against the brake shoe 10. The first surface 12A of the composition friction first layer 12 is adapted to contact the surface of a railway vehicle wheel during a braking operation. In one specific use, the composition friction first layer 12 is compatible for use with a safety wheel of a railway vehicle.

ASTM shear test results for typical friction material versus the two layer brake head material including the resilient second layer 14 of the brake shoe 10 were performed. The friction material results are characterized by a region of plastic yield, or permanent deformation, near the maximum deflection point where a fracture occurs. Ultimate strength is in the region above 30,000 lbf. Calculations based on these results indicate a modulus of elasticity in the range of 400-470 ksi (mid-range would be 435,000 lbs/in²).

The resilient material provided as the resilient second layer 14 associated with the brake shoe 10 is characterized by a much lower modulus of elasticity, which does not include any appreciable plastic yield before the maximum deflection limit of the test equipment is reached. Ultimate strength is in the region below 12,000 lbf. Calculations based on these results indicate a modulus of elasticity in the range of 50-75 ksi (mid-range would be 62,500 lbs/inch²).

The results of this testing shows that the characteristic or typical friction material used in prior art brake shoe applications is too rigid (relatively high modulus and ultimate strength means that the material does not “bend” much before it “breaks”, whereas the resilient material yields, or deforms, in an elastic manner such that it retains its shape and integrity by stretching but not “breaking”). In a brake shoe product without the backing plate, the use of the resilient material as the resilient second layer 14 in brake shoe 10, avoids the occurrence of breakage (or fracture) at the engagement surfaces which interact with the mounting screw threads.

Accordingly, the resilient material of the second layer 14 acts to encapsulate the more friable friction material of the first layer 12. The resilient material provides a tough and resilient skin layer of material, which applies a circumferential compressive force on the exterior surfaces of the fasteners or mounting screws 18 that penetrate the back of the brake shoe 10. In addition to the compressive force on penetrating fastener surfaces, the second layer 14 prevents localized breakage of the material around the contact perimeter on the mounting screws 18, thereby maintaining the holding power of the fastener interface.

The resilient stratum performs two additional functions. First, the thickness and toughness of the resilient material is sufficient to interact with the mounting screws 18 as the body or host portion of a threaded joint. Second, the properties of the resilient material provide resistance to breakdown of the threaded connection due to vibration and lateral impacts. As is known in the art, vibration and lateral impacts enlarge the perimeters of holes drilled in wooden and other composition types of brake shoes.

It is to be understood that the manufacturing process employed for the manufacture of the present invention brake shoe may require the addition of a second formula to mix and mill prior to the molding process, as well as placement of stratum material in the mold prior to charging the mold with composition friction material. Furthermore, due to the resilient properties of the present invention brake shoe, removal of flashing after the molding process may require use of additional tools and/or effort to meet appearance standards.

The invention has been described with reference to the desirable embodiments. Modifications and alterations will occur to others upon reading and understanding the preceding detailed description. It is intended that the invention be construed as including all such modifications and alterations insofar as they come within the scope of the appended claims or the equivalents thereof.

The invention claimed is:

1. A railway brake shoe comprising:
(a) a first layer constructed of a composite friction material; and
(b) a second layer constructed of a resilient composition material, said second layer attached to a surface of said first layer, said second layer adapted to receive at least one fastener therein.

2. The railway brake shoe of claim 1 wherein the second layer is adapted to be removably secured to a brake head with said at least one fastener.

3. The railway brake shoe of claim 1 wherein said second layer is adapted to receive said at least one fastener extending therethrough and wherein said first layer is adapted to receive a predetermined portion of said at least one fastener therein.

4. The railway brake shoe of claim 1 wherein said resilient composition material of said second layer is capable of applying a circumferential compressive force to an exterior surface of said at least one fastener.

5. The railway brake shoe of claim 3 wherein said resilient composition material of said second layer is capable of preventing localized breakage of said composite friction material of said first layer around a contact perimeter of the first layer with said at least one fastener and said second layer.

6. The railway brake shoe of claim 1 wherein said second layer is integrally molded with said first layer.

7. The railway brake shoe of claim 1 wherein said at least one fastener comprises a plurality of fasteners and wherein said plurality of fasteners comprises screws.

8. A brake shoe for attachment to a brake head for use with a railway vehicle, said brake shoe comprising:
(a) a first layer constructed of a composite friction material, said first layer having a first surface and a second surface, said first surface capable of contacting such wheel during a braking operation;
(b) a second layer constructed of a resilient composition material, said second layer having a first surface and a second surface, said first surface attached to said second surface of said first layer; and
(c) at least one aperture extending into said second layer, said at least one aperture adapted to receive at least one mechanical fastener therein for removable securement of said second surface of said second layer to such brake head.

9. The brake shoe of claim 8 wherein said at least one aperture extends through said second layer.

10. The brake shoe of claim 9 wherein said first layer includes at least one aperture extending a predetermined distance therein, said at least one aperture extending into said first layer positioned in alignment with said at least one aperture extending through said second layer and adapted to receive a predetermined portion of said at least one mechanical fastener extending through said second layer.

11. The brake shoe of claim 8 wherein said resilient composition material of said second layer is capable of applying a circumferential compressive force to an exterior surface of said at least one mechanical fastener.

12. The brake shoe of claim 10 wherein said resilient composition material of said second layer is capable of preventing localized breakage of said composite friction material of said first layer around a contact perimeter of the first layer with said at least one mechanical fastener and said second layer.

13. The brake shoe of claim 8 wherein said second layer is integrally molded with said first layer.

14. The brake shoe of claim 8 wherein said at least one mechanical fastener comprises a screw.

15. The brake shoe of claim 8 wherein said first surface of said first layer composite friction material is compatible for use with a safety wheel of a railway vehicle.

16. A method of securing a brake shoe to a brake head for use with a railway vehicle, said method comprising the steps of:
(a) providing a brake shoe comprising:
(i) a first layer constructed of a composite friction material; and
(ii) a second layer constructed of a resilient composition material attached to a surface of said first layer;
(b) providing a first aperture extending through said second layer;
(c) providing a second aperture in alignment with said first aperture, said second aperture extending a predetermined distance into said first layer of said brake shoe; and
(d) attaching said brake shoe to a brake head by means of a mechanical fastener extending into said first and second apertures.

17. The method of claim 16 wherein said resilient composition material of said second layer is capable of applying a circumferential compressive force to an exterior surface of said at least one mechanical fastener and preventing localized breakage of said composite friction material of said first layer around a contact perimeter of the first layer with said mechanical fastener and said second layer.

18. The method of claim 16 wherein said second layer is integrally molded with said first layer.

19. The method of claim 16 wherein said step of providing first and second apertures comprises forming a plurality of first and second apertures in said first and second layers.

20. The method of claim 19 wherein said step of attaching said brake shoe to said brake head comprises the use of a plurality of screws.
